(19) United States
(12) Patent Application Publication
(10) Pub. No.: US 2025/0263305 A1
(43) Pub. Date: Aug. 21, 2025

(54) EXTRACTION PROCESS FOR REDUCING THE ALUNITE CONTENT FROM TAILINGS, PRODUCT, AND ITS USE

(71) Applicant: Vale S.A., Rio de Janeiro (BR)

(72) Inventors: Ruberlan GOMES DA SILVA, Belo Horizonte (BR); Danielly Juliana FIGUEIREDO COUTO, Belo Horizonte (BR)

(21) Appl. No.: 19/057,864

(22) Filed: Feb. 19, 2025

(30) Foreign Application Priority Data
Feb. 19, 2024 (BR) 102024003231-4

(51) Int. Cl. C01F 7/745; C01B 33/12; C01D 5/00; C22B 1/02; C22B 3/08; C22B 3/22; C22B 21/00

(52) U.S. Cl. CPC C01F 7/745; C01B 33/126; C01D 5/008; C22B 1/02; C22B 3/08; C22B 3/22; C22B 21/0023

(57) ABSTRACT

The present invention relates to a process for extracting aluminum, potassium and alunite sulfate from sulfide copper ore tailings with the aim of reducing the alunite content in the ore tailings, to the products obtained through this process and their uses. The process includes at least a step of heat treatment of the raw material and a leaching step. The process generates a first coproduct rich in quartz and a second coproduct rich in aluminum and/or potassium sulfates. The proposed process route has a high percentage of aluminum, potassium and alunite sulfate extraction, with effective reduction of the alunite content in the ore tailings, low cost and the obtaining of coproducts that can be subsequently marketed and/or disposed of in the environment in a safe manner and contributes to the practice of circular economy.

### FIELD OF INVENTION

The present invention falls within the field of mining and deals with a process for extracting aluminum, potassium and alunite sulfate with the aim of reducing the alunite content in ore tailings, especially when disposed of in the environment. The invention also relates to the products obtained by said process and their uses.

### BACKGROUND OF THE INVENTION

In the field of mining, tailings are unavoidable products of the treatment processes to which ores are subjected and are generated alongside the material of interest. These, in turn, have an impact on the environment, as they occupy large areas for disposal, cause vegetation suppression and affect the physical and chemical quality of surface and groundwater, among other effects. In this context, alunite may be present in tailings obtained after the flotation of a copper ore. Alunite is a potassium aluminum sulfate hydroxide (KAl₃(SO₄)₂(OH)₆). It is soluble in water and releases Al³⁺ and H⁺ ions into the liquid effluent when in contact with water, reducing the pH and increasing the concentration of Al³⁺ ions and other metals/nonmetals in the effluent, which can have a strong environmental impact if this liquid effluent is disposed of in the environment.

Conventionally, there are several possibilities for reducing the alunite content in the tailings to be disposed of, including separation in hydrocyclones and through flotation, but none of these alternatives manages to obtain tailings with low enough concentrations of alunite in their composition. However, the state of the art also includes efforts to extract alunite using different routes that achieve a more significant reduction in alunite content, including, for example, pyrometallurgical and/or hydrometallurgical process routes.

Document CN105217658 discloses a method for extracting aluminum and potassium from alunite through acid leaching by direct pressurization. The proposed method does not require heat treatment of the raw material, since pressurized leaching is considered sufficient to remove the desired compounds. However, it is known that pressure leaching is expensive, operates with high-cost closed and pressurized tanks, requires high energy consumption and the use of more complex equipment in the pulp solid-liquid separation step.

Document WO2019149293, on the other hand, presents a method for processing alunite ore that consists of crushing, grinding and flotation of raw alunite ore. The enriched alunite ore is calcined and leached with a 5% m/m to 20% m/m sodium carbonate solution. However, sodium carbonate is a very expensive reagent and difficult to obtain on the market, which makes the process unaffordable. In addition, the process route proposed in this document generates liquid effluent rich in sodium sulfate, which requires specific and expensive treatment for disposal or to generate a by-product for the market.

Document U.S. Pat. No. 4,031,182 describes a process for recovering aluminum from alunite ore. The process consists of calcining the alunite ore to remove molecular water and sulfur in the form of SOₓ gases and converting potassium aluminum sulfate hydroxide (alunite) into alumina (Al₂O₃); leaching the calcination product with water and filtering to remove potassium sulfate and other soluble sulfates; hot leaching the water leaching residue with sulfuric acid solution to convert the alumina into soluble aluminum sulfate, followed by filtering to remove silicon dioxide and other solid impurities; crystallization of the aluminum sulfate to further remove impurities; heating of the residue to convert the aluminum sulfate to alumina and eliminate any remaining sulfur as SOₓ gases; and digesting the calcined alumina with sodium hydroxide under standard Bayer conditions at a high A/C ratio (aluminum/caustic) to provide a high A/C ratio solution from which a “sandy” aluminum hydroxide is precipitated. The proposed process operates at a high temperature to thermally decompose alunite and obtain SO₂ and Al₂O₂+SiO₂. In the present invention there is complete thermal decomposition with the generation of gases containing SO₂ and obtaining aluminum by leaching with a sulfuric acid solution, involving high energy consumption and the need to process the SO₂ gases to produce sulfuric acid or by washing with an alkaline solution, for example hydrated lime.

The paper “Leaching kinetics and mechanism of alunite from alunite tailings in highly concentrated KOH solution” by Meng-Jie Luo, Cheng-Lin Liu, Jin Xue, Ping Li and Jian-Guo Yu describes the direct leaching of alunite from alunite tailings in highly concentrated KOH solution. Under suitable leaching conditions, such as temperature below 90° C. and KOH concentration above 13.5 mol/L, most of the alunite is dissolved while kaolinite, dickite and quartz remain in the residue. This document explores the extraction of alunite through basic leaching and, like sodium carbonate, potassium hydroxide is not a raw material that is easy to obtain on the market or at a low cost.

As explained above, there are efforts in the state of the art dedicated to alunite extraction processes using different methods and raw materials. However, there is still a need for a thermally efficient, low-cost process route that achieves a high rate of elimination of alunite from copper ore tailings and reduces the environmental impact of disposing of tailings from these ores in nature.

As will be fully detailed below, the present invention aims to solve the problems of the state of the art described above in a practical and efficient way.

### SUMMARY OF THE INVENTION

The present invention relates to a process for extracting aluminum, potassium and alunite sulfate from sulfide copper ore tailings with the aim of reducing the alunite content in the ore tailings. Such tailings are commonly disposed of in the environment, generating a significant environmental impact due to the release of Al³⁺ and H⁺ ions into the liquid effluent and, for this reason, the extraction of alunite using the process proposed by the present invention becomes relevant.

The invention also refers to the products obtained by this process, rich in quartz and rich in aluminum and/or potassium sulfate, and their uses.

The objectives and other advantages of the present invention will become clearer from the following description.

### BRIEF DESCRIPTION OF THE FIGURES

FIG. 1 illustrates an operational flowchart of the alunite extraction process route of the present invention, showing how the first coproduct rich in quartz is obtained.

FIG. 2 illustrates an operational flowchart of the alunite extraction process route of the present invention, showing the treatment of the liquor rich in aluminum and/or potassium sulfate and obtaining the second coproduct rich in aluminum and/or potassium sulfate.

FIG. 3 illustrates a comparison of the extraction of Al, Cu and K from different mining tailings according to the examples of the present invention after carrying out the alunite extraction process of the present invention.

FIG. 4 illustrates the characterization of two portions of the coproduct rich in aluminum and/or potassium sulfate obtained after the alunite extraction process of the present invention.

### DETAILED DESCRIPTION OF THE INVENTION

In view of the existing problem regarding the disposal of mining tailings in the environment and the real possibility of contamination, the need to treat and extract metals from these tailings has become recurrent and challenging.

In particular, sulfide copper ore tailings rich in alunite which, in contact with water, release Al³⁺ ions that hydrolyze and release H⁺ ions, reducing the pH of the effluent and promoting the leaching of other metals/nonmetals, can cause a strong environmental impact if this liquid effluent is disposed of in the environment.

To solve this existing technical problem, the present invention proposes a process for extracting alunite from sulfide copper ore tailings.

In order to achieve the objectives described above, the present invention provides a process for the extraction of alunite from tailings comprising at least the following steps: i) subjecting the raw material (1.1) to mild heat treatment (1) with controlled temperature and residence time to promote only dehydroxylation of the alunite and obtain a less crystalline calcined product, ii) subjecting the calcined product resulting from step i) to acid leaching (3) using mineral acid (3.1), which may be hydrochloric acid, nitric acid or sulfuric acid, or similar acids and mixtures thereof, with sulfuric acid being preferred; and iii) obtaining an extraction of between about 75% m/m and about 100% m/m, preferably between about 85% m/m and about 95% m/m from the sulfide copper tailings, as well as a pulp as a by-product, in which the process generates coproducts from the said by-product that can be useful for various applications. Thus, through the proposed process, it is possible to treat waste, reducing possible environmental impacts, and give application to by-products that would previously have been discarded, promoting the practice of circular economy.

According to the present invention, the raw material (1.1) of the process in question consists of tailings obtained from the flotation of a sulfide copper ore, preferably with a quartz content ranging from about 20% m/m to about 80% m/m and alunite content ranging from about 5% m/m to about 90% m/m, there may also be, in smaller quantities, sulfides (pyrite, chalcopyrite, bornite, covellite, chalcocite) ranging from about 0.5% m/m to about 5.0% m/m, and clay minerals (kaolinite, pyrophyllite, dickite), ranging from about 5% m/m to about 25% m/m.

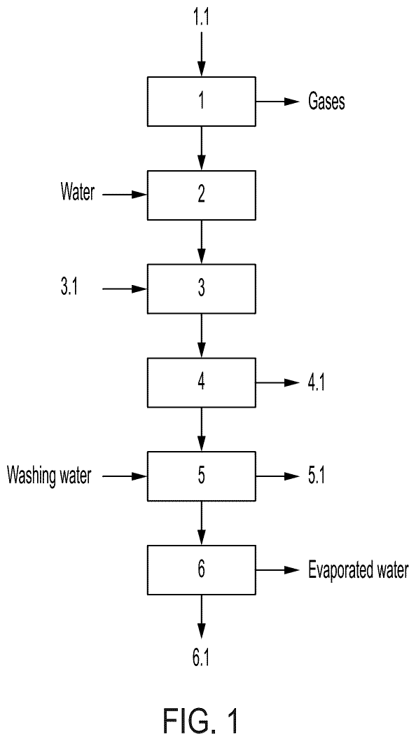

FIG. 1 illustrates an operational flowchart of the extraction process for reducing the alunite content described by the present invention. The first heat treatment step (1) of the raw material (1.1) consists of the mild heat treatment of the copper tailings to eliminate the hydroxyl groups from the molecule (dehydroxylation). This heat treatment is carried out in equipment resistant to high temperatures, preferably in a rotary kiln or oven. The residence time and temperature in the thermal step must be properly controlled to avoid the formation of a refractory crystalline structure in the following leaching step, which would prevent the extraction of alunite. Thus, the temperature used in this step can vary from about 550° C. to about 850° C., preferably between about 650° C. and about 750° C., with a residence time between about ½ and about 2 hours, preferably about 1 hour.

The solids obtained in the thermal step are then cooled (2) and subjected to acid leaching (3) in a tank without the need for heating, with an appropriate residence time and solids content, preferably ranging from 10% to 50%, more preferably 30%, to maximize the extraction of alunite. The mineral acid (3.1) to be used in this step can be hydrochloric acid, nitric acid or sulfuric acid, or similar acids and mixtures thereof, with sulfuric acid being preferred. At this step, the residence time in the tank can vary from about 1 hour to about 8 hours, preferably between about 2 hours and about 4 hours, with a temperature between about 25° C. and about 90° C., preferably between about 60° C. and about 80° C. The pH of the reaction should be less than 3.0, preferably greater than 1.5 and less than 2.5, with a specific consumption of about 150 to about 450 kg of acid (3.1), which can be 98% m/m sulfuric acid, per ton of raw material (1.1) used, and can be copper tailings, preferably between about 250 and about 350 kg/t, resulting in a proportion used of about 300 kg of acid (3.1) per ton of raw material (1.1).

After this step, a liquor containing aluminum and potassium sulfate is obtained, corresponding to the extraction of alunite from the copper tailings, ranging from about 80% to about 95%, preferably between about 85% and about 90%. Also advantageously, the process of the present invention has as a by-product a pulp containing a solid rich in quartz and a liquor rich in aluminum and potassium sulfate. This pulp is then thickened and filtered (4) to separate the solid rich in quartz and the liquor rich in aluminum and potassium sulfate (4.1). Thickening is carried out in a thickener with added flocculant and a thickening rate varying between about 0.010 m²/t/day and about 0.020 m²/t/day, preferably about 0.015 m²/t/day. The underflow from the thickener containing pulp with between about 30% and about 60% solids, preferably about 45% solids, is then conveyed to a filtration step (4) in filter presses or vacuum filters, with a filtration rate ranging from about 200 to about 400 kg/h/m², preferably about 300 kg/h/m² to obtain the solid rich in quartz with moisture ranging from about 10% m/m to about 30% m/m, preferably about 20% m/m.

The quartz-rich solid is then treated by means of additional steps, which include washing the solid with process water (5), generating a poor liquor (5.1), drying (6) and cooling, generating the first coproduct rich in quartz (6.1). The first coproduct rich in quartz (6.1) comprises SiO₂ contents ranging from about 75% m/m to about 100% m/m, preferably between about 85% m/m and about 95% m/m, and can be used for disposal in the environment, used in the construction of dam slopes or even marketed for civil construction in the production of blocks, ceramics or road paving. This way, the first coproduct rich in quartz (6.1) obtained after the process of the invention can be safely disposed of in the environment, or even commercialized, generating revenue and reducing the environmental impact of copper ore processing. It is estimated that 700 to 750 kg of coproduct rich in quartz (>88% SiO₂ by weight) is produced for every 1000 kg of ore feed.

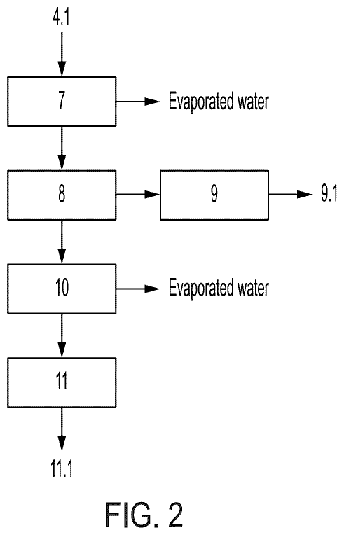

As can be seen in the operational flowchart in FIG. 2, the liquor rich in aluminum and potassium sulfate (4.1), which was obtained after step (4), is then subjected to thermal evaporation (7) to generate the first salt of aluminum and potassium double sulfate and water vapor during crystallization. Water vapor is condensed to recover thermal energy and water to be recycled. At this step, approximately 75% of the total solvent volume is reduced. Next, the liquor is crystallized by cooling (8, 9) with the generation of more steam that is condensed for additional recovery of thermal energy and water. After this step, a first portion of the second coproduct rich in aluminum and/or potassium sulfate (9.1) is obtained, which is a salt. These steps are carried out in evaporators and crystallizers.

The rest of the volume of liquor then goes through a new evaporation (10) and a drying, compacting and cooling process (11) to obtain a second portion of the second coproduct rich in aluminum and/or potassium sulfate (11.1), which is also a salt.

The two portions (9.1, 11.1) obtained from the second coproduct can have the same or different compositions, and can be potassium sulfate (K₂SO₄), aluminum sulfate (Al₂(SO₄)₃·15-20H₂O) and/or a mixture of acid potassium sulfate and hydrated aluminum (KHSO₄·Al₂(SO₄)₃·10-20H₂O). This second coproduct rich in aluminum and/or potassium sulfate (9.1, 11.1), containing between about 3.5% m/m and about 8.5% m/m of aluminum, about 1.0% m/m and about 5.0% m/m of potassium and between about 25% m/m and about 50% m/m of sulfate, can then be marketed for use in the treatment of swimming pool water, as a raw material for the production of aluminum sulfate and/or potassium sulfate, or as an antibacterial, antiseptic and healing agent in the health and beauty sector. It is estimated that 150 to 250 kg of coproduct rich in aluminum and/or potassium sulfates will be produced for a 1000 kg ore feed.

After the whole process of extracting alunite, it is possible to obtain the elimination of between about 75% m/m and about 100% m/m, preferably between about 85% m/m and about 95% m/m of this mineral from the sulfide copper tailings.

From the process of extracting alunite from sulfide copper tailings as described by the present invention, it is possible to achieve a 20% to 30% reduction in the amount of tailings to be disposed of at the ore processing site, reducing the environmental impact and the cost of raising the dam, as well as extending the life of the mine by increasing the deposit reserve. In addition, coproducts rich in quartz and aluminum and/or potassium sulfate are generated, which can be marketed and generate additional revenue. If the coproduct rich in quartz without alunite in its composition is not sold, there is also the possibility of disposing of this coproduct in the weather without generating acidic liquid effluent containing dissolved metals/nonmetals, which could cause serious damage to the environment.

In addition, industrial operations to obtain copper sulfide concentrate from copper sulfide ore containing alunite become more sustainable. The circular economy technique is directly applied, with between 20% and 80% of the entire mass of sulfide copper ore being used to generate products for the domestic and foreign markets. Generally, the overall mass recovery in sulfide copper ore flotation projects is very low, ranging from 2% to 5%.

The present invention also relates to the products obtained through this process and their respective uses. The first product obtained has a SiO₂ content of more than 88% by weight and its use is related to the use in the construction of dam embankments or even its commercialization for civil construction in the production of blocks, ceramics or road paving. In addition, this first product can be safely disposed of in the environment without generating acidic liquid effluent containing dissolved metals/nonmetals, or even commercialized, generating revenue and reducing the environmental impact of copper ore processing. The second product obtained comprises potassium sulfate, aluminum sulfate and/or a mixture of acidic potassium sulfate and hydrated aluminum, which can be used in the treatment of swimming pool water, or as a raw material to produce aluminum sulfate and/or potassium sulfate, or as an antibacterial, antiseptic and healing agent in the health and beauty sector.

The description that has been given so far of the object of the present invention should be considered only as a possible embodiment or embodiments, and any characteristics introduced therein should be understood only as something that has been written to facilitate understanding. Therefore, they should not be considered as limiting the invention, which is limited to the scope of the claims.

The examples presented illustrate the scope of the products generated through the process proposed herein.

### EXAMPLES

Laboratory tests were carried out to demonstrate the effect of the alunite extraction process on different parameters.

### Example 1

Firstly, two control tests were carried out without the heat treatment step of the raw material. The sulfide copper tailings were subjected directly to leaching with sulfuric acid at a temperature of 80° C. with two dosages (155 kg/t and 312 kg/t), a residence time of 4 hours and a solids content in the pulp of 30% m/m. After the tests, the extraction of aluminum was only 1%, the extraction of copper was 22% and the extraction of potassium was 0%, in other words, the extraction of alunite was extremely low using only acid leaching, without the previous step of heat treatment of the raw material, which is fundamental to the present invention.

### Example 2

Tests were then carried out to obtain the best conditions for the heat treatment of the raw material. The raw material was thermally decomposed in an oven at a temperature of 750° C. and a residence time of 1 hour. Leaching was then carried out with 98% m/m sulfuric acid (312 kg/t) at a temperature of 80° C., a residence time of 4 hours and a solids content of 30% m/m in the pulp. After this test, aluminum extraction was 46%, copper extraction was 52% and potassium extraction was 96%.

### Example 3

The raw material was thermally decomposed in an oven at a temperature of 750° C. and a residence time of 3 hours. Leaching was then carried out with 98% m/m sulfuric acid (312 kg/t) at a temperature of 80° C., a residence time of 4 hours and a solids content in the pulp of 30% m/m. After this test, aluminum extraction was 41%, copper extraction was 51% and potassium extraction was 96%, similar results to Example 2, but with a shorter residence time.

Therefore, the residence time of 1 hour (EXAMPLE 2) was considered more advantageous for the heat treatment step of the raw material.

### Example 4

Tests were then carried out to obtain the best conditions for the acid leaching step. The raw material was thermally decomposed in a rotary kiln at a temperature of 750° C. and a residence time of 1 hour. Leaching was then carried out with sulfuric acid at a temperature of 80° C., a residence time of 4 hours, 312 kg/t of raw material and with 30% by weight of solids in the pulp. After this test, aluminum extraction was 53%, copper extraction was 73% and potassium extraction was 97%.

Thus, under dynamic conditions in the heat treatment step, using a rotary kiln instead of an oven (static condition), the extraction of aluminum and potassium is more favorable.

### Example 5

The raw material was thermally decomposed in a rotary kiln at a temperature of 750° C. and a residence time of 1 hour. This was followed by leaching with sulfuric acid at a temperature of 80° C., a residence time of 4 hours, 312 kg/t of raw material with 40% by weight of solids in the pulp. After this test, aluminum extraction was 56%, copper extraction was 59% and potassium extraction was 96%. The rheology of the pulp with 40% m/m solids proved more difficult to keep in suspension, compromising the subsequent thickening and filtration steps, so the condition with 30% m/m solids was maintained.

### Example 6

The raw material was thermally decomposed in a rotary kiln at a temperature of 750° C. and a residence time of 1 hour. This was followed by leaching with sulfuric acid at a temperature of 25° C., a residence time of 4 hours, 312 kg/t of raw material with 30% by weight of solids in the pulp. After this test, aluminum extraction was 26%, copper extraction was 49% and potassium extraction was 83%.

Thus, the temperature of 80° C. (EXAMPLE 4) is important to ensure high extractions of aluminum and potassium and consequently alunite.

### Example 7

Example 4 was repeated to generate masses of products to be used in the tests for the following steps of the process route. The thermal decomposition of the raw material was carried out in a rotary kiln at a temperature of 750° C. and a residence time of 1 hour. This was followed by leaching with sulfuric acid at a temperature of 80° C., a residence time of 4 hours, 312 kg/t of raw material with 30% by weight of solids in the pulp. After this test, aluminum extraction was 53%, copper extraction was 61% and potassium extraction was 97%.

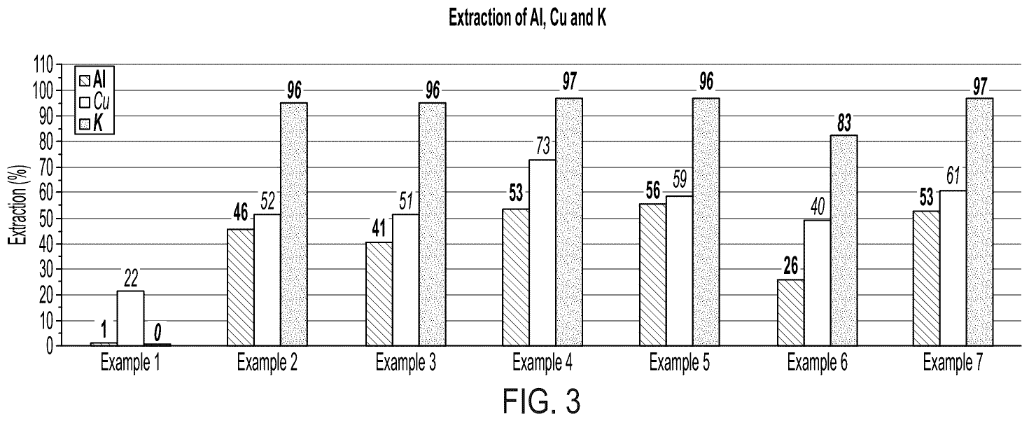

FIG. 3 shows a comparison of the extractions of Al, Cu and K from Examples 1 to 7 described above.

As can be seen, the best extraction results were obtained in Examples 4 and 7, since the mass ratio of Al/K extracted is the closest to the stoichiometry for alunite, indicating an extraction of alunite close to 100%. The lowest Al, Cu and K extraction results were obtained in Example 6, with an acid leaching temperature of 25° C. Example 5, on the other hand, seems to have extracted additional aluminum from other minerals, since it has the highest Al/K mass ratio.

### Example 8

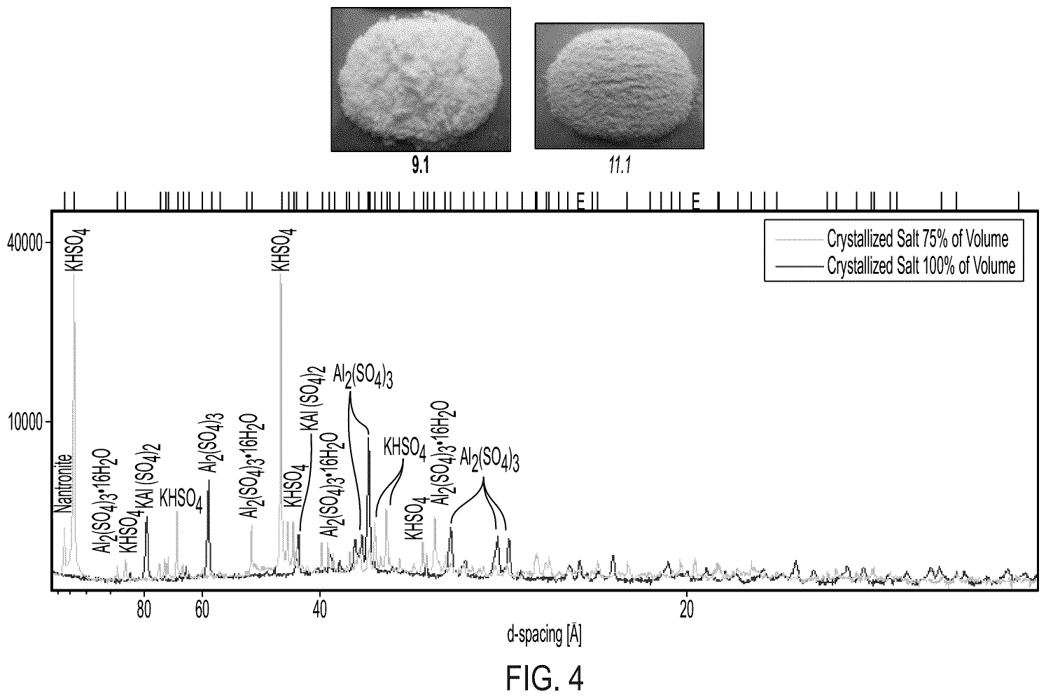

Next, the evaporation, crystallization and solid-liquid separation steps were applied to the pulp obtained after acid leaching with the best conditions described above. Evaporation and crystallization of the solvent (water) were carried out in the laboratory by controlled heating the pulp obtained after leaching on an electric plate. Solid-liquid separation was carried out using a Büchner funnel, filter paper and a vacuum pump. The first coproduct rich in quartz and the second coproduct rich in potassium and/or aluminum sulfate were obtained. In the first step 75% of the solvent (water) was evaporated and in the second step 100% of the solvent (water) was evaporated. The characterization of the two portions of coproduct rich in aluminum and/or potassium sulfate obtained after this step can be seen in FIG. 4.

Based on the data and information in the text, it is clear that the present invention solves the problem of reducing alunite content in tailings effectively, with a high percentage of alunite extraction, low cost and obtaining coproducts that can later be marketed and/or disposed of in the environment in a safe manner, generating future income and corroborating the application of the circular economy technique in the processing of sulfide copper ores.

Numerous variations in the scope of protection of the present application are permitted. This reinforces the fact that the present invention is not limited to the configurations/concretizations described above.

1. An extraction process for reducing alunite content from tailings, comprising:
i) subjecting raw material (1.1) to heat treatment (1),
(ii) subjecting calcined product resulting from step i) to acid leaching (3) using mineral acid (3.1), selected from the group consisting of hydrochloric acid, nitric acid and sulfuric acid, or similar acids or mixtures thereof; and
iii) obtaining the extraction of alunite with a content of between about 75% m/m and about 100% m/m from the tailings,
wherein
the heat treatment step (1) of the raw material (1.1) is carried out at a temperature of between about 550° C. and about 850° C., with a residence time of between about ½ and about 2 hours,
the leaching step (3) is conducted with a residence time of between about 1 hour and about 8 hours, at a temperature of between about 25° C. and about 90° C., with an acidic pH, and
wherein the said process generates a pulp rich in metals and minerals as a by-product.

2. The extraction process for reducing the alunite content according to claim 1, wherein the raw material (1.1) fed to said process consists of tailings from a flotation of a sulfide copper ore.

3. The extraction process for reducing the alunite content according to claim 2, wherein the tailings obtained from the flotation of sulfide copper ore have a quartz content ranging from about 20% m/m to about 80% m/m and alunite content ranging from about 5% m/m to about 90% m/m, and there may also be, in smaller quantities, sulfides (pyrite, chalcopyrite, bornite, covellite, calcocite), between about 0.5% m/m and about 5% m/m, and clay minerals (kaolinite, pyrophyllite, dickite), between about 5% m/m and about 25% m/m.

4. The extraction process for reducing the alunite content according to claim 1, wherein the heat treatment step (1) of the raw material (1.1) is conducted in a rotary or static furnace (oven).

5. The extraction process for reducing the alunite content according to claim 1, wherein the heat treatment step (1) of the raw material (1.1) is conducted at a temperature between about 650° C. and about 750° C.

6. The extraction process for reducing the alunite content according to claim 1, wherein the heat treatment step (1) of the raw material (1.1) is conducted with a residence time of about 1 hour.

7. The extraction process for reducing the alunite content according to claim 1, wherein the leaching step (3) is conducted in a tank.

8. The extraction process for reducing the alunite content according to claim 1, wherein the leaching step (3) is conducted at a temperature between about 60° C. and about 80° C.

9. The extraction process for reducing the alunite content according to claim 1, wherein the leaching step (3) is conducted with a residence time between about 2 hours and about 4 hours.

10. The extraction process for reducing the alunite content according to claim 1, wherein the leaching step (3) is conducted at a reaction pH greater than 1.5 and less than 2.5.

11. The extraction process for reducing the alunite content according to claim 1, wherein the leaching step (3) is conducted using sulfuric acid.

12. The extraction process for reducing the alunite content according to claim 1, wherein the leaching step (3) is conducted with a specific consumption between about 150 kg and about 450 kg of acid (3.1) per ton of raw material (1.1), preferably between about 250 kg and about 350 kg of acid (3.1) per ton of raw material (1.1), resulting in a proportion used of about 300 kg of acid (3.1) per ton of raw material (1.1).

13. The extraction process for reducing the alunite content according to claim 1, wherein the alunite extraction is at contents between about 85% m/m to about 95% m/m.

14. The extraction process for reducing the alunite content according to claim 1, wherein the pulp rich in metals and minerals obtained in step iii) is then thickened and filtered (4), obtaining a solid rich in quartz and a liquor rich in aluminum and/or potassium sulfate (4.1).

15. The extraction process for reducing the alunite content according to claim 14, characterized in that wherein the solid rich in quartz is treated by means of additional steps that include washing said solid with process water (5), drying (6) and cooling, generating a first coproduct rich in quartz (6.1).

16. The extraction process for reducing the alunite content according to claim 15, characterized in that wherein the first coproduct rich in quartz (6.1) comprises SiO₂ contents between about 75% m/m and about 100% m/m, preferably between about 85% m/m and about 95% m/m.

17. The extraction process for reducing the alunite content according to claim 14, wherein the liquor rich in aluminum and potassium sulfate (4.1) is treated by means of additional steps that include thermal evaporation (7) to generate a first salt of double aluminum and potassium sulfate and water vapor, condensation of the water vapor with energy and water recovery, crystallization of the liquor (4.1) by cooling (8, 9) with additional steam generation, and additional condensation with energy and water recovery, obtaining a first portion of a second coproduct rich in aluminum and potassium sulfate (9.1).

18. The extraction process for reducing the alunite content according to claim 17, wherein a remainder of a liquor volume is subjected to the additional steps of evaporation (10), drying and cooling (11), obtaining a second portion of the second coproduct rich in aluminum and/or potassium sulfates (11.1).

19. The extraction process for reducing the alunite content according to claim 17, wherein the second coproduct (9.1, 11.1) consists of potassium sulfate, aluminum sulfate and/or a mixture of acid potassium sulfate and hydrated aluminum.

20. The extraction process for reducing the alunite content according to claim 17, wherein the second coproduct rich in aluminum and/or potassium sulfate (9.1, 11.1) is in the form of a salt.

21. Product, A product obtained through the process as defined in claim 1, wherein the product comprises SiO₂ contents ranging from about 75% m/m to about 100% m/m.

22. The product according to claim 21, wherein the product comprises SiO₂ contents between about 85% m/m and about 95% m/m.

23. A product obtained through the process as defined in claim 1, wherein the product comprises potassium sulfate, aluminum sulfate and/or a mixture of acid potassium sulfate and hydrated aluminum, containing between about 3.5% m/m and about 8.5% m/m of aluminum, between about 1.0% m/m and about 5.0% m/m of potassium and between about 25% m/m and about 50% m/m of sulfate.

24. A dam slope construction, civil construction or road paving comprising the product of claim 21.

25. A swimming pool water treatment an antiseptic, or a healing agent comprising the product of claim 21.
